(19) United States
(12) Patent Application Publication
(10) Pub. No.: US 2016/0051085 A1
(43) Pub. Date: Feb. 25, 2016

(54) OVEN BASKET

(71) Applicant: COOK'N FIT, Fexhe-le-Haut-Clocher (BE)

(72) Inventors: Denis Dalcq, Orp-Jauche (BE); Stéphane Delbrouck, Fexhe-le-Haut-Clocher (BE)

(73) Assignee: COOK'N FIT, Fexhe-le-Haut-Clocher (BE)

(21) Appl. No.: 14/780,442

(22) PCT Filed: Mar. 26, 2014
(86) PCT No.: PCT/EP2014/056103

§ 371 Date: Sep. 25, 2015

(30) Foreign Application Priority Data
Mar. 26, 2013 (BE) BE2013/0203

(51) Int. Cl. A47J 37/04

(52) U.S. Cl. CPC A47J 37/047

(57) ABSTRACT

Oven basket designed to rotate about an axis, comprising a first basket part and a second basket part that rotate as one, said first part sliding with respect to said second part. Each of the basket parts has a distal side wall, that is to say a side wall furthest away from the user, perpendicular to said axis, and a proximal side wall. Said basket has a first projection extending from said distal side wall of the second part of the basket and a second projection extending from said proximal side wall of the second part, said projections being aligned along the rotation axis of the basket. Said proximal side walls of said first basket part and of said second basket part are cold or lukewarm walls that do not substantially conduct heat.

The invention relates to an oven basket describing a closed volume arranged to rotate around a basket rotation axis, said basket comprising a first basket part and a second basket part, said first and second basket parts secured to one another in rotation slidingly entering the opening, said first basket part sliding in a direction parallel to said rotation axis relative to said second basket part, each of the first and second basket parts having a distal side wall and being perpendicular to said basket rotation axis, each of the first and second basket parts having a proximal side wall, said basket having a first integral projection and extending from said distal side wall of said second basket part toward the outside of said basket, and a second integral projection extending from said proximal side wall of said second basket part toward the outside of said basket, said first and second projections being aligned with one another along said basket rotation axis, said first projection being provided to be driven by a driveshaft.

Such a basket is known from document U.S. Pat. No. 4,295,419, which discloses an oven designed to receive it. Unfortunately, such a basket requires a complex assembly system. Indeed, to house that basket, the oven disclosed in the prior document must include a door to ensure tightness and appropriate separation between the outside and the inside of the oven, in order to channel odors. Next, on the one hand, the basket must be driven by means of a drive shaft cooperating with a distal projection present on the basket, and on the other hand a proximal projection also present on the basket must be fitted into a receiving orifice to maintain it in position. However, this document remains particularly silent regarding the rotating basket support.

Also known from document U.S. Pat. No. 5,994,672 is a hot air oven formed by a basket comprising first and second basket parts, said basket rotating in a cooking chamber. A solid axis crossing through the basket supports said first and second basket parts and allows the rotation thereof. Furthermore, a heat distribution system supplies the basket with hot air and a ventilation system removes the hot air from the cooking chamber through the rear of the oven. Furthermore, a catalytic converter is mounted just next to the cooking chamber to clean the heated air after cooking.

Unfortunately, the presence of the solid axis crossing through the basket disclosed in this prior document complicates the assembly of the two basket parts as well as the insertion of the basket previously assembled to the structure of the oven. Furthermore, during assembly, for example after having disassembled the basket during cleaning, the solid through axis must be inserted into a multitude of orifices following one after the other, which makes the assembly particularly complex and involves great manufacturing precision for the basket-axis system to be aligned with the structure of the oven in order to ensure correct operation thereof. The alignment of the basket-axis system may be made even more difficult due to deformations, for example deformations present under the weight of food loaded in the basket to be placed in the oven. This alignment is also problematic when the basket has deformations related to the wear of the basket, this in particular being observed following multiple openings and closings of the basket during its use.

Furthermore, the presence of this solid axis that crosses through the basket means that the food collides with it during rotation of the basket during the cooking time, which results in crushing or destroying the food. Furthermore, the temperature difference between the solid axis crossing through the basket and the air contained in the volume of the basket results in the food risking remaining stuck on the axis.

The invention aims to resolve the aforementioned drawbacks by proposing an oven basket with a simple configuration, both for the oven and for the basket, that is easy to assemble and clean.

To that end, the oven basket according to the invention as described in the beginning of this document is characterized in that the proximal side walls of said first and second basket part are cold or lukewarm walls, substantially not conducting heat. The presence of the proximal walls of the first and second cold or lukewarm basket parts, conducting little or no heat, makes it possible to greatly simplify the design of the oven by no longer requiring an additional door, but without generating odor exhaust, loss of heat and/or disruption to the rotation of the basket. Furthermore, the basket is easy to disassemble and is thus very easy to clean, in particular, able to go in the dishwasher.

According to the invention, the second basket part remains housed in the oven in the open position of the first basket part when the user wishes to change or unload the basket and said second basket part comprises means for suspending the basket in the form of first and second projections. This allows the basket to remain well stabilized during the multiple opening and closing events of the basket during its use. According to the invention, the first part of the basket is provided to slide relative to the second basket part until complete opening of the latter, like a drawer. It is preferable for the first basket part to have an aerated and light shape so that the user can handle it easily and thus minimize its weight to optimize production costs.

Advantageously, said first basket part of the oven basket according to the invention has an opening delimited by a perimetric edge, said perimetric edge being formed by a rim of said distal side wall of said first basket part and by a rim of said proximal side wall of said first basket part, and two rims of an outer surface of said first basket part, said second basket part having an opening delimited by a perimetric edge, said perimetric edge being formed by a rim of said distal side wall of said second basket part and by a rim of said proximal side wall of said second basket part, and two rims of an outer surface of said second basket part, said two outer surface rims of said second basket part being provided with a guide rail arranged to house said two outer surface rims, optionally provided with a bead, or lip, for example protruding, of said first basket part.

The presence of the well-defined edge on the first basket part and on the second basket part makes it possible for the first part to slide easily and fit completely in the second basket part when the basket is in the closed position, like a drawer and such that the basket forms a closed volume. Furthermore, according to the invention, it is easy, for an ordinary user, to open and close the basket, reload the basket and/or clean it, since the user can easily and completely disassemble the various elements once it is empty, for example to wash it in a common dishwasher.

Advantageously, according to the invention, the surface of said proximal wall of said first basket part and the surface of said proximal wall of said second basket part are each respectively larger than the proximal wall of said first basket part and said second basket part fitted in said closed volume.

Preferably, the surface of the proximal wall of the first and second basket parts is formed directly by or coated with a material substantially not conducting heat. In particular, this proximal wall can be formed by polyamide elements separated by an air knife.

Preferably, the proximal wall of the first basket part has a gripping means. This gripping means can assume different embodiments. It may involve a notch in which a handle will be inserted to open, empty and/or close the basket, an exiting protruding handle, fastened or molded jointly to the proximal wall of the first basket part or hollow handle, directly in said proximal wall of the first basket part, for example obtained by molding.

In one particular embodiment, said first basket part is a lower part designed to receive the food to be placed in the oven.

In one embodiment, said first projection is a hollow projection arranged to house a driveshaft. In one alternative, the first projection is a solid projection arranged to be housed in a driveshaft.

Advantageously, the rotation axis of the oven basket according to the invention is off-centered relative to a median longitudinal axis of said basket allowing said first basket part to have a different volume capacity from a volume capacity of said second basket part, and preferably smaller.

Advantageously, according to the invention, said basket comprises at least one sub-basket with a cover, in particular a double-grate, arranged to be placed and fitted on said first basket part. Furthermore, the basket can be used with several accessories to facilitate the cooking of certain foods, for example the sub-basket with the cover makes it possible for the user to wedge croquettes, such as cheese croquettes, and thus to cook them uniformly while retaining their original shape. Foods that cannot withstand a rotational movement in a drum, which may damage them and turn them to purée, are thus positioned in a thin sub-basket with a cover that pinches the foods and confines them in a volume in which rotation is not possible. These accessories provide great freedom to the user to cook all types of food to be placed in the oven.

Other embodiments of the basket according to the invention are mentioned in the appended claims.

The present invention also relates to an oven comprising a closable container having a cover, comprising a heat source making it possible to blow heat inside said closable container, comprising a horizontal driveshaft arranged to be driven by a motor situated opposite said opening, comprising control means to rotate the motor and bring that heat source to a predetermined temperature, and a basket according to the invention, in which said first basket part has a gripping means, said oven further comprising a support means for said basket, said closable container being closed by said cold or lukewarm proximal side walls, substantially not conducting heat from the first and second basket parts. Consequently, the access to the oven is very simple for the user inasmuch as there is no door to be opened, while avoiding untimely heat losses, which are detrimental to the energy performance as well as odor leakage, and while avoiding burn risks. Furthermore, the oven therefore has a compact shape with no outside door.

Furthermore, the particular configuration of the basket and the oven according to the present invention has made it possible to achieve an oven that is, as previously mentioned, very compact, but that does not require any complex basket assembly step. On the contrary, the suspension projections of the basket are secured to the basket, thus making it possible to do without an axis crossing through the basket and reducing the reassembly of the basket after cleaning, while making it possible to eliminate the door of the oven and lastly, to obtain a first basket part that is like a drawer that one opens, fills and closes before starting the operation of the oven. The startling simplicity of the basket, as well as the oven, its compactness and simplicity of use during operation make it a product with surprising advantages whereof the basket can be placed in the dishwasher many times for cleaning before being easily reassembled.

Advantageously, according to the invention, said basket support means comprises at least two cavities, a first distal support cavity and a second proximal support cavity, said first distal support cavity being arranged to receive said first projection of said basket, said second proximal support cavity being arranged to receive said second projection of said basket, said first and second support cavities being connected to one another such that they do not hinder the opening of said first basket part by sliding when the oven is stopped. The shape of the cavities is adapted based on the shape of the projections such that, when the basket is suspended on the axis, it remains stable during rotational movements and during multiple opening and closing events of the basket during its use. The cooperation between the cavities and the projections plays a decisive role in correct rotation of the basket being able to be performed, i.e., a rotation that presents minimal friction favoring regular cooking of food to be placed in the oven and increasing the lifetime of the basket, while ensuring the simplicity of assembly and disassembly of the basket from its oven.

In one particular embodiment of the invention, the first distal support cavity is concave and includes a bottom on which said first projection of said basket rests, said second proximal support cavity also being concave and also including a bottom on which said second projection of said basket rests.

In another embodiment according to the invention, said second proximal support cavity is a through cavity.

Advantageously, according to the invention, said basket support means has a horizontal longitudinal part that is fastened to the inside of said closable container on the ceiling of said oven, from which a distal lateral part and a proximal lateral part extend downward, which respectively include, at their ends extending transversely inward, said first distal support cavity and said second proximal support cavity.

Advantageously, according to the invention, said basket support means comprises a proximal side support wall and a distal side support wall, substantially parallel to said proximal side walls of said basket, said distal side support wall being provided with said first distal support cavity arranged to house and support the first projection of said basket, said proximal side support wall being provided with said second proximal support cavity arranged to house and support a second projection of said basket, said proximal side support wall and the distal side support wall being connected to one another by at least one outer wall, said proximal side support wall being extended by at least two parts of that outer wall that extend in a direction parallel to said rotation axis, said distal side support wall also being extended by at least two parts of that outer wall that extend in a direction parallel to said rotation axis, at least part of that outer wall, extending from the distal side support wall, being connected to one of said parts of that outer wall extending from the proximal side support wall, said support means of the basket being arranged to house said basket with said first and second projections of the basket suspended in said first and second support cavities.

This support means of the basket having a shape substantially surrounding the first basket part, either by making it possible simply to receive a cross-section therein (such as a frame around the cross-section), but also to suspend the basket of the first and second projections resting in the support cavities presented on the support means, either by surrounding much more than the cross-section, such as by a half-cylinder shape, from which the side parts can be omitted to reduce the weight thereof. In this configuration, the bottom part of the half-cylinder or pseudo-half-cylinder in which the half-cylinder wall parts are hollowed out makes it possible to collect the pieces of food and crumbs that escape during cooking. The support means is preferably inserted via the opening of the closable container forming the oven by sliding, or inserted in a double side rail, or any other equivalent means.

The support means is therefore easy to disassemble and clean. It is, inter alia, the cooperation with that support means that makes it possible to do away with the outer door of the oven by providing support means for the rotation axis formed by the aligned projections in the horizontal median part of the closable container so that the configuration of the oven remains simple and compact.

This support means can have more or less solid side walls and the manufacturer has a wide choice of designs and manufacturing modes to propose a support means that is effective and profitable to produce.

The invention will now be described in more detail using the drawings, which illustrate one preferred embodiment of the oven basket.

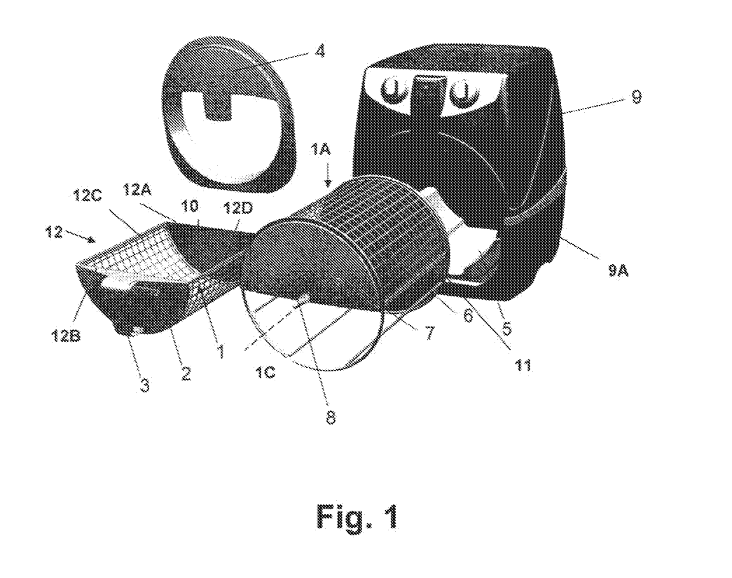

FIG. 1 is a perspective view of an oven, for example a fry oven, comprising the oven basket according to the present invention.

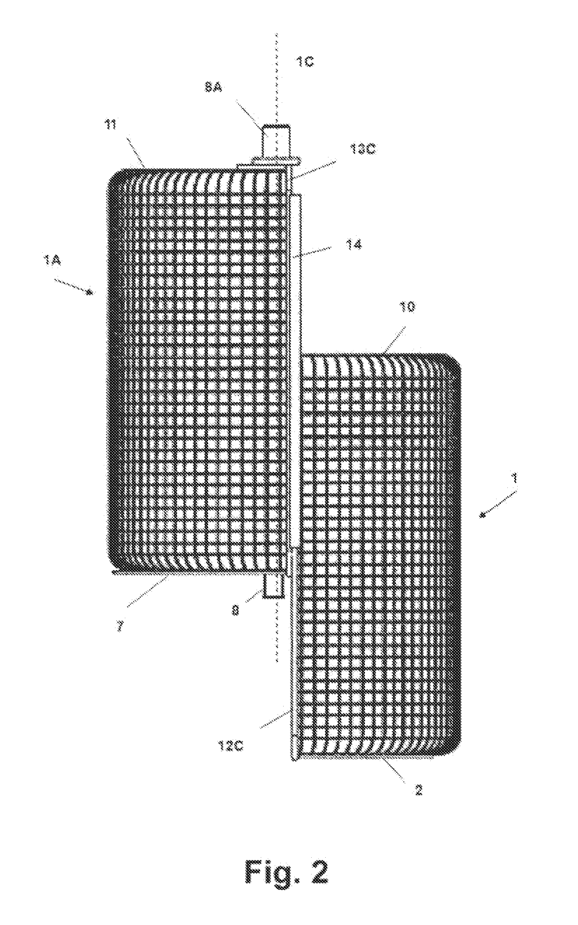

FIG. 2 is a perspective view of the basket illustrating the sliding of the first basket part relative to the second basket part.

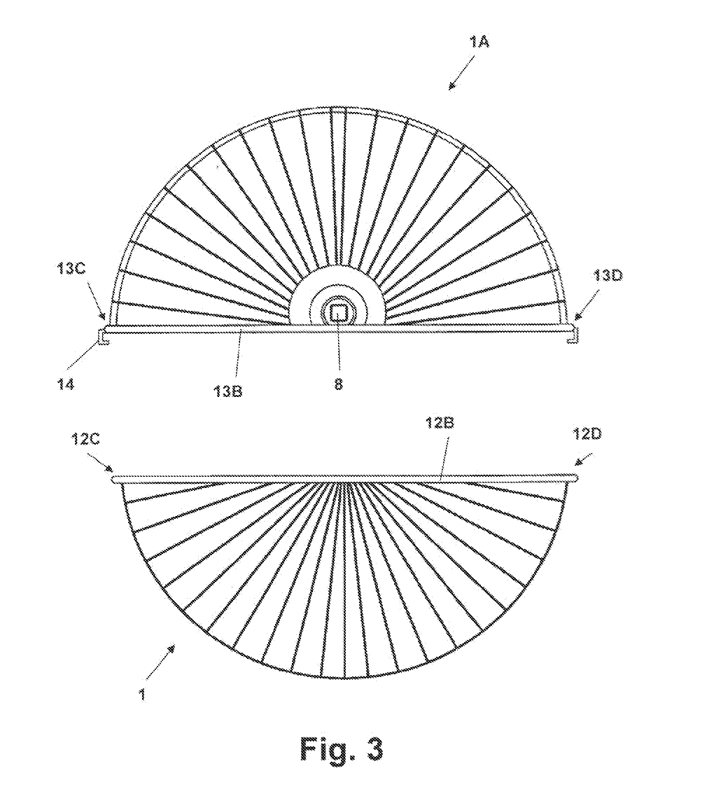

FIG. 3 shows a front view of the first and second basket parts, the rim of the proximal side wall of the first basket part and the rim of the proximal side wall of the second basket part.

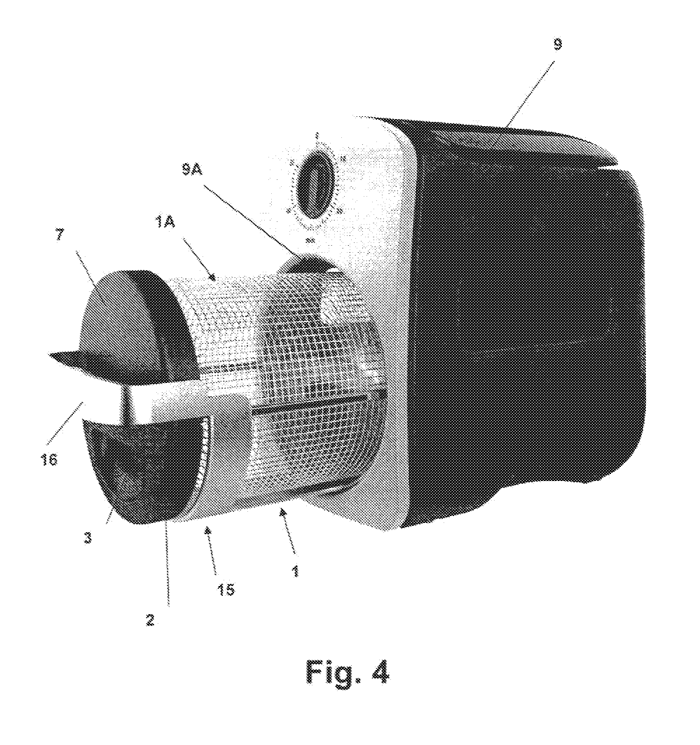

FIG. 4 illustrates the arrangement of the basket in the oven in the closed position according to the invention.

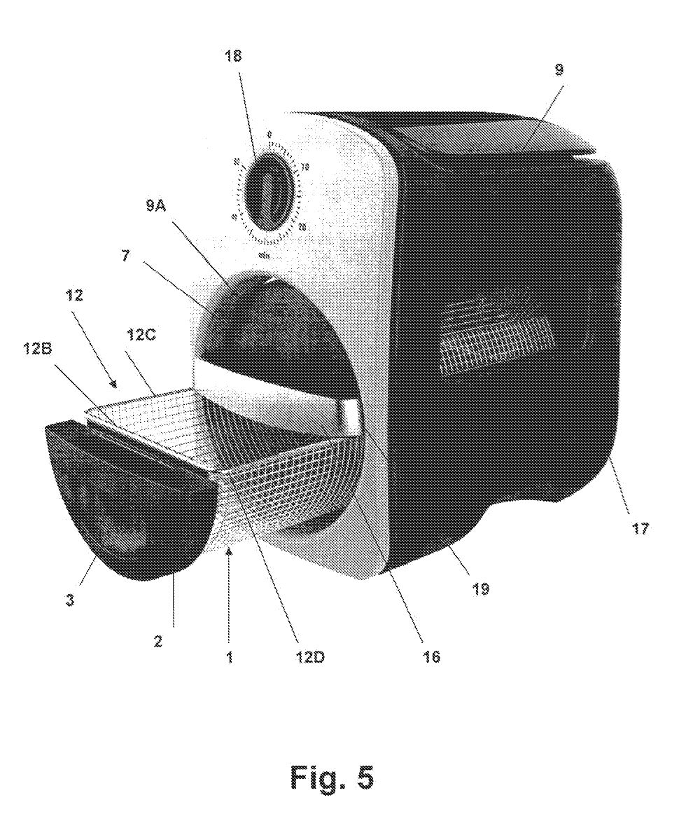

FIG. 5 illustrates the arrangement of the basket in the oven in the open position according to the invention.

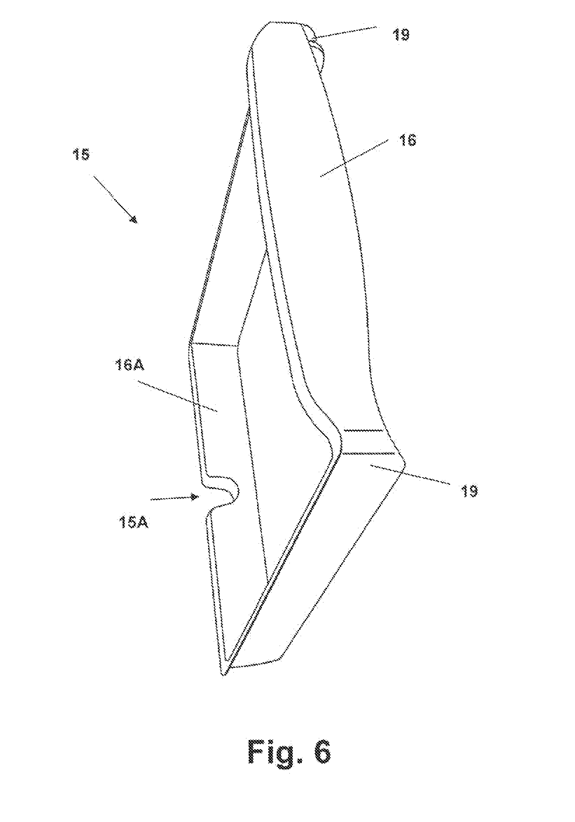

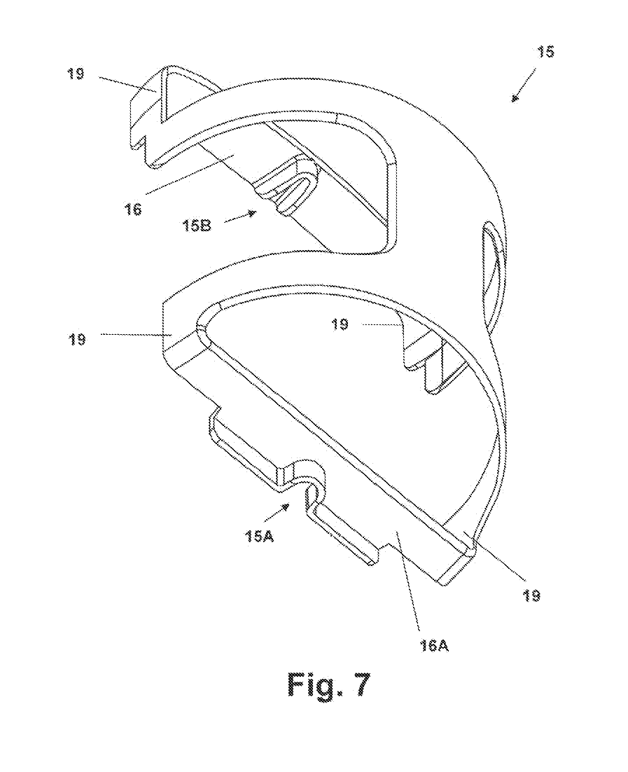

FIGS. 6 and 7 illustrate alternatives of the support means for the basket according to the invention.

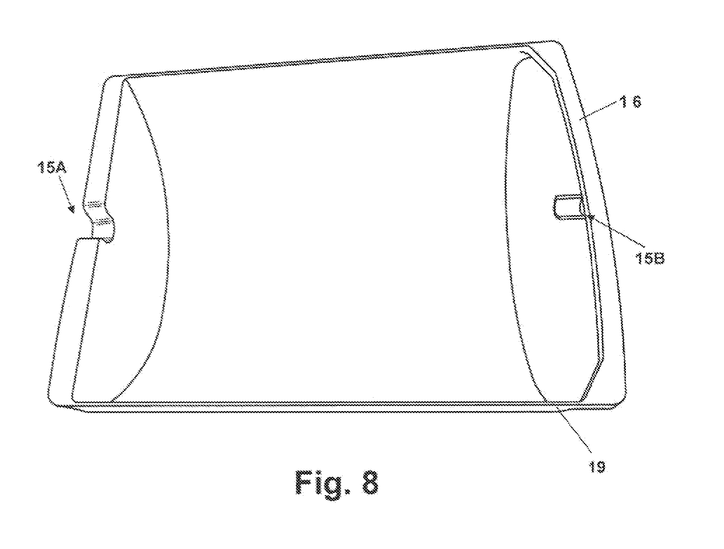

FIG. 8 illustrates another basket support means according to the invention.

In the figures, identical or similar elements bear the same references.

FIG. 1 is a perspective view of an example of an oven, for example for fries, according to the invention in which the oven basket 1+1A is shown outside the closable container 9, which is provided to house the basket 1+1A. In the illustrated embodiment, the support means 4 also acts as a cover for a front part of the oven.

FIG. 1 illustrates that the oven basket 1+1A according to the invention has a rotating cylindrical structure describing a closed volume 6, the first 1 and second 1A baskets being secured to one another in rotation around the rotation axis 1C. The rotation axis 1C is off-centered relative to a median longitudinal axis of the basket 1+1A, which makes it possible for the first basket part 1 to have a different volume capacity than the volume capacity of the second basket part 1A, preferably smaller.

The oven basket 1+1A comprises a distal side basket wall 10+11, i.e., the wall furthest from the user, and a proximal side wall formed by the proximal side wall 2 of the first basket part 1 and by the proximal side wall 7 of the second basket part 1A. The distal side basket wall 1+1A is formed by the distal side wall 10 of the first basket part 1 and by the distal side wall 11 of the second basket part 1A. This distal side wall 10+11 is perpendicular to the rotation axis 1C, and can be solid or aerated (for example, when it involves a grate or any other configuration having openings with various shapes).

The basket 1+1A is provided for simple and practical use, the weight of the basket playing an important role to that end. This aerated shape and the manufacture of the basket from a light material makes it possible to reduce the weight of the basket. The grate of the cylindrical structure defines the closed volume 6, which is an empty volume. This empty volume 6 allows a free movement of the food inside the basket during the rotation during the cooking time. Thus, the foods retain their original shape and the cooking is done uniformly, giving the foods the appearance desired by the user.

The first basket part 1 has a gripping means in the form of a handle 3, the gripping means also being able to be a hollow handle or simply a hook in which the user can fasten a mobile handle. The proximal side walls 2, 7 of the first 1 and second 1A basket part are cold or lukewarm walls, substantially not conducting heat. Thus, the user can grasp the basket directly from the outside of the oven to open the basket by pulling on the gripping means without risking being burned.

The second basket part 1A has a first projection 8A secured to and extending from the distal side wall 11 of the second basket part 1A toward the outside of the basket, as illustrated in FIG. 2. Furthermore, the second basket part 1A comprises a second projection 8 secured to and extending from the proximal side wall 7 of the second basket part 1A. The projections 8, 8A are both aligned along a same rotation axis of the basket 1C. The first projection 8A can be a hollow projection arranged to house a drive shaft (not illustrated), or a solid projection arranged to be housed in a drive shaft (not shown). The horizontal driveshaft is arranged to be driven by a motor situated opposite said opening 9A of the closable container 9.

The oven according to the invention as illustrated comprises a first distal support cavity arranged to receive said first projection 8A of said basket through which the driveshaft passes and a basket support means 15 in the form of a cover in this illustrated embodiment, which comprises at least one second proximal support cavity 15B, arranged to receive said second projection 8 of said basket, said support means being provided not to hinder the opening of said first basket part 1 by sliding when the oven is stopped.

FIGS. 2 and 3 illustrate the arrangement of the first basket part 1 and the second basket part 1A. The first basket part 1 has an opening delimited by the perimetric edge referenced under number 12 in FIG. 1, that perimetric edge 12 being formed by the rim 12A of the distal side wall of the first basket part 1, by the rim 12B of the proximal side wall of the first basket part 1, and by two rims 12C, 12D of the outer surface of the first basket part 1. The second basket part 1A has an opening delimited by the perimetric edge 13, that perimetric edge 13 being formed by the rim (not shown) of the distal side wall of the second basket part 1A, by the rim 13B of the proximal side wall of the second basket part 1A, and by two rims 13C, 13D of the outer surface of the second basket part 1A. The two rims 13C, 13D of the outer surface of the second basket part 1A are provided with a guide rail 14 arranged to house the two outer surface rims 12C, 12D present on the first basket part 1, those two rims optionally being provided with a bead or a lip, for example protruding. The guide rail 14 can be a continuous rail like that shown in FIG. 2, but may also be formed by rail segments with varied lengths and shapes. This makes it possible for the first basket part 1 to slide easily on the second basket part 1A, and makes it easy for the user to open and close the oven basket 1+1A during use thereof. Thus, the basket 1+1A and the oven can be assembled and disassembled easily to facilitate their use and cleaning.

According to the embodiment illustrated in FIG. 4, when the two parts 1, 1A of the basket are fitted in one another, the surface thus formed by the combination of the surface of the proximal wall 2 of the first basket part 1 and the surface of the proximal part 7 of the second basket part 1A is larger than the surface delimited by the circumference fitted in the closed volume 6. The surface of the proximal wall 2 of the first basket part 1 and the surface of the proximal wall 7 of the second basket part 1A can be made from or covered with a material that does not conduct heat and that can be substantially tight.

Furthermore, these two proximal walls 2, 7 of the first basket part 1 and the second basket part 1A form the means for closing the closable container 9. The oven according to the invention therefore does not require a door. This also facilitates the use of the oven, since the user does not need to open the door to access the basket and thus to load or unload the food to be placed in the oven in or from that basket. The absence of a door also reduces the manufacturing costs and the risks of the user being burned by the door.

Accessories can be provided to facilitate the use of the basket 1+1A depending on the type of food to be placed in the oven. The basket 1+1A as illustrated is particularly appropriate, for example to cook French fries. The French fries are placed inside the basket 1+1A and the cooking is done uniformly during the rotation of the basket during the cooking time.

However, if the user wishes to cook cheese croquettes, they will be deformed during the rotation of the basket during the cooking time. In that case, one example accessory may consist of a sub-basket with a cover, in particular a double grate, arranged to be placed and fitted on said first basket part 1. This double grate makes it possible to fasten and retain the cheese croquettes to guarantee that they retain their original shape when they pass through the oven.

FIGS. 4 and 5 illustrate the arrangement of the basket in the oven when the basket 1+1A has a closed position (FIG. 4) and an open position (FIG. 5) according to the invention. It will be noted that the oven has a compact shape. The oven further comprises the closable container 9, which can have a window 17 to allow the user to monitor the cooking of the food to be placed in the oven. The oven also comprises a heat source making it possible to blow heat, i.e., hot air, inside the closable container 9. On the outer upper part of the closable container 9, an aeration hole is provided and arranged to make it possible to control the exhaust (outlet) of heat outside the container 9. On the front face of the closable container 9, control means 18 are visible. Actuating them makes it possible to rotate the motor, situated opposite the opening 9A. The oven further comprises support means 15 for the basket having a proximal side support wall 16 visible on the front face of the closable container 9.

FIG. 4 shows the basket 1+1A with the first 1 and second 1A basket parts secured to one another following the sliding of the first basket part 1 on the second basket part 1A.

In this figure, the basket support means 15 surrounds and receives the basket 1+1A by being placed below the latter, but in an alternative according to the present invention, the support means is simply in the form of a frame and comprises said two cavities, the first distal support cavity 15A and the second proximal support cavity 15B, said first distal support cavity 15A being arranged to receive said first projection 8A of said basket, said second proximal support cavity 15B being arranged to receive said second projection 8 of said basket, said first 15A and second 15B support cavities being connected to one another by a frame-shaped structure such that they do not hinder the opening of said first basket part 1 by sliding when the oven is stopped.

The oven has a modern and simple shape, being assembled in a compact manner to provide the market with an oven having smaller dimensions, which is practical for modern kitchens and storage spaces, which tend to be limited. Of course, other arrangements and configurations of the internal and external components of the oven may arise and fall within the scope of the present invention. The drawings are not limiting.

FIG. 8 illustrates another embodiment of the basket support means 15. The basket support means 15 of FIG. 8 supports and receives the basket 1+1A. The basket support means 15 comprises at least two cavities, a first distal support cavity 15A and a second proximal support cavity 15B, the latter of which may or may not be a through cavity. The first distal support cavity 15A is arranged to receive the first projection 8A of the basket, while the second proximal support cavity 15B is arranged to receive the second projection of the basket. The first 15A and second 15B support cavities are connected to one another such that they do not hinder the opening of said first basket part 1 by sliding when the oven is stopped.

The first distal support cavity 15A is concave and includes a bottom in which the first projection 8A of the basket bears and rests. Likewise, the second proximal support cavity 15B is concave and includes a bottom on which the second projection 8 of the basket bears. In this way, the basket 1+1A is suspended in the oven and is partially housed in the support means. The shape of the cavities 15A, 15B corresponds to the shape of the projections 8A, 8, which plays a decisive role in making the basket stable during its rotation. In this way, the suspended basket performs a regular rotation, which is desired so that the food to be placed in the oven is cooked uniformly and the lifetime of the basket is increased. Furthermore, the suspension of the basket facilitates the disassembly of the oven, for example during a cleaning operation.

The basket support means 15 comprises a proximal side support wall 16 and a distal side support wall 16A, which are substantially parallel to the proximal side walls 2, 7 of the basket illustrated in FIG. 1. The distal side support wall 16A is provided with the first distal support cavity 15A arranged to house and support the first projection 8A of the basket. The proximal side support wall 16 is provided with the second proximal support cavity 15B arranged to house and support the second projection 8 of the basket. Preferably, the distance between that proximal side support wall 16 and the proximal side walls 2, 7 of the first 1 and second 1A basket parts must be sufficient to allow the rotation of the basket, which must be able to rotate without problem, i.e., without encountering obstacles that could cause a blockage, the basket support means 15 remaining in a stationary position during the rotation.

The proximal side support wall 16 and the distal side support wall 16A are connected to one another by at least one unique outer wall 19 that extends between the two in a direction parallel to the rotation axis. The basket support means 15 has a length at least greater than a basket length, optionally added to a thickness of the gripping means so as to allow easy rotation of the basket in the basket support means 15.

Of course, the present invention is in no way limited to the embodiments described above, and changes may be made thereto without going beyond the scope of the appended claims. For example, according to one embodiment, the basket support means has a horizontal longitudinal part that is fastened to the inside of the closable container on the ceiling of the oven, from which a distal side part and the proximal side part extend downward, which respectively include, their ends extending transversely inward, the first distal support cavity and the second proximal support cavity. This support means has a shape that is particularly useful when the configuration or assembly of the oven is favored by the support means retained in the upper part of the closable container.

1. An oven basket providing a closed volume arranged to rotate around a basket rotation axis, said basket comprising a first basket part and a second basket part, said first and second basket parts secured to one another in rotation slidingly entering the opening, said first basket part sliding in a direction parallel to said rotation axis relative to said second basket part, each of the first and second basket parts having a distal side wall and being perpendicular to said basket rotation axis, each of the first and second basket parts having a proximal side wall, said basket having a first integral projection and extending from said distal side wall of said second basket part toward the outside of said basket, and a second integral projection extending from said proximal side wall of said second basket part toward the outside of said basket, said first and second projections being aligned with one another along said basket rotation axis, said first projection being provided to be driven by a driveshaft, wherein the proximal side walls and of said first and second basket part are cold or lukewarm walls, substantially not conducting heat.

2. The oven basket according to claim 1, wherein said first basket part has an opening delimited by a perimetric edge, said perimetric edge being formed by a rim of said distal side wall of said first basket part and by a rim of said proximal side wall of said first basket part, and two rims of an outer surface of said first basket part, said second basket part has an opening delimited by a perimetric edge, said perimetric edge being formed by a rim of said distal side wall of said second basket part and by a rim of said proximal side wall of said second basket part, and two rims of an outer surface of said second basket part, said two outer surface rims of said second basket part being provided with a guide rail arranged to house said two outer surface rims.

3. The oven basket according to claim 1, wherein the surface of said proximal wall of said first basket part and the surface of said proximal wall of said second basket part are each respectively larger than the proximal wall of said first basket part and said second basket part fitted in said closed volume.

4. The oven basket according to claim 1, wherein said first basket part is a lower part designed to receive the food to be placed in the oven.

5. The oven basket according claim 1, wherein said first projection is a hollow projection arranged to house a driveshaft, or in that the first projection is a solid projection arranged to be housed in a driveshaft.

6. The oven basket according to claim 1, wherein the rotation axis of the oven basket according to the invention is off-centered relative to a median longitudinal axis of said basket allowing said first basket part to have a different volume capacity from a volume capacity of said second basket part, and preferably smaller.

7. The oven basket according to claim 1, wherein said basket comprises at least one sub-basket with a cover arranged to be placed and fitted on said first basket part.

8. An oven comprising a closable container having an opening, comprising a heat source configured to blow heat inside said closable container, comprising a horizontal driveshaft arranged to be driven by a motor situated opposite said opening, comprising control means to rotate the motor and bring that heat source to a predetermined temperature, and a basket according to claim 1, in which said first basket part has a gripping means, said oven further comprising a support means for said basket and said closable container being closed by said cold or lukewarm proximal side walls, substantially not conducting heat from the first and second basket parts.

9. The oven according to claim 8, wherein it comprises a first distal support cavity arranged to receive said first projection of said basket, and in that said first support means comprises at least one second proximal support cavity, arranged to receive said second projection of said basket, said support means being provided not to hinder the opening of said first basket part by sliding when the oven is stopped.

10. The oven according to claim 8, wherein said basket support means comprises at least two cavities, a first distal support cavity and a second proximal support cavity, said first distal support cavity being arranged to receive said second projection of said basket, said second proximal support cavity being arranged to receive said second projection of said basket, said first and second support cavities being connected to one another such that they do not hinder the opening of said first basket part by sliding when the oven is stopped.

11. The oven according to claim 9, wherein said first distal support cavity is at least concave and includes a bottom on which said first projection of said basket rests, said second proximal support cavity also being concave and also including a bottom on which said second projection of said basket rests.

12. The oven according to claim 11, wherein said second proximal support cavity is a through cavity.

13. The oven according to claim 8, wherein said basket support means has a horizontal longitudinal part that is fastened to the inside of said closable container on the ceiling of said oven, from which a distal lateral part and a proximal lateral part extend downward, which respectively include, at their ends extending transversely inward, said first distal support cavity and said second proximal support cavity.

14. The oven according to claim 8, wherein said basket support means comprises a proximal side support wall and a distal side support wall, substantially parallel to said proximal side walls of said basket, said distal side support wall being provided with said first distal support cavity arranged to house and support the first projection of said basket, said proximal side support wall being provided with said second proximal support cavity arranged to house and support a second projection of said basket, said proximal side support wall and the distal side support wall being connected to one another by at least one outer wall, said proximal side support wall being extended by at least two parts of that outer wall that extend in a direction parallel to said rotation axis, said distal side support wall also being extended by at least two parts of that outer wall that extend in a direction parallel to said rotation axis, at least part of that outer wall, extending from the distal side support wall, is connected to one of said parts of that outer wall extending from the proximal side support wall, said support means of the basket being arranged to house said basket with said first and second projections of the basket suspended in said first and second support cavities.

15. The oven according to claim 8, wherein said basket support means has a length at least greater than a basket length, optionally with an added thickness of said gripping means so as to allow an easy rotation of said basket in said basket support means.

16. The oven basket according to claim 2, wherein said two outer surface rims are provided with one of a bead and a lip that protrudes from said first basket part.

17. The oven basket according to claim 7, wherein said cover includes a double grate.
